(19) United States
(12) Patent Application Publication
(10) Pub. No.: US 2026/0058588 A1
(43) Pub. Date: Feb. 26, 2026

(54) ELECTRIC MOTOR DRIVE DEVICE AND AIR CONDITIONER

(71) Applicant: Mitsubishi Electric Corporation, Tokyo (JP)

(72) Inventors: Yohei TAKIGAWA, Tokyo (JP); Fumiaki SHIBATA, Tokyo (JP); Kazushi IKURUMI, Tokyo (JP); Takamasa ONISHI, Tokyo (JP)

(21) Appl. No.: 19/102,440

(22) PCT Filed: Oct. 21, 2022
(86) PCT No.: PCT/JP2022/039250

§ 371 Date: Feb. 10, 2025

(51) Int. Cl. H02P 27/06; F25B 49/02; H02P 6/12

(52) U.S. Cl. CPC H02P 27/06; F25B 49/025; H02P 6/12; F25B 2600/021; F25B 2600/024

(57) ABSTRACT

An electric motor drive device includes: a three-phase diode bridge which rectifies and converts a three-phase AC voltage into a DC voltage; an electrolytic capacitor which smooths a DC voltage; a DC reactor provided between the three-phase diode bridge and the electrolytic capacitor; an inverter which converts a DC voltage smoothed by the electrolytic capacitor into an AC voltage and outputs the AC voltage to a motor; a voltage detecting unit which detects a DC voltage output from the three-phase diode bridge; and an inverter control unit which detects an imbalanced state of the three-phase AC voltage on the basis of a DC voltage value which is a detection value of the DC voltage obtained by the voltage detecting unit, and controls the inverter on the basis of a detection result of the imbalanced state.

### FIELD

The present disclosure relates to an electric motor drive device and an air conditioner.

### BACKGROUND

There is an electric motor drive device that includes a three-phase AC diode bridge and an inverter, converts power supplied from a three-phase AC power supply into three-phase AC power having a desired voltage and frequency, and supplies the three-phase AC power to a motor (for example, Patent Literature 1).

In the electric motor drive device having a configuration including the three-phase diode bridge, when an input three-phase AC voltage is imbalanced, an imbalance occurs in an input current, and pulsation also occurs in a DC voltage after rectification in the three-phase diode bridge. When pulsation occurs in the DC voltage after rectification, there is a possibility that a defect occurs such as breaker trip or a failure of a component mounted on a substrate. In response to such a problem, an electric motor drive device described in Patent Literature 1 determines whether or not the three-phase AC is in an imbalanced state on the basis of a line voltage of a three-phase AC power supply. When the three-phase AC is in an imbalanced state, the electric motor drive device protects circuit components by reducing an output of an inverter.

### CITATION LIST

### Patent Literature

Patent Literature 1: Japanese Patent Application Laid-open No. 2017-22920

### SUMMARY OF INVENTION

### Problem to be Solved by the Invention

In the conventional electric motor drive device described above, in the processing of determining whether or not a three-phase AC is in an imbalanced state, the line voltage is estimated, and an imbalance rate calculated on the basis of an estimation result of the line voltage is compared with a predetermined threshold to detect the imbalanced state. For this reason, in the conventional electric motor drive device, it is necessary to provide a voltage detection circuit for at least two phases of three-phase AC, which leads to an increase in size of the device, and further, processing becomes complicated and a processing load increases. For this reason, it is desired to achieve an electric motor drive device capable of downsizing the device and reducing a processing load.

The present disclosure has been made in view of the above, and an object of the present disclosure is to provide an electric motor drive device capable of achieving downsizing of the device and reduction of a processing load.

### Means to Solve the Problem

To solve the above problem and achieve an object, an electric motor drive device according to the present disclosure includes: a three-phase diode bridge to rectify a three-phase alternating-current (AC) voltage, to convert the AC voltage into a direct-current (DC) voltage; a smoothing capacitor to smooth the DC voltage; a DC reactor provided between the three-phase diode bridge and the smoothing capacitor; an inverter to convert the DC voltage smoothed by the smoothing capacitor into an AC voltage, and output the AC voltage to a motor; a voltage detecting unit to detect a DC voltage output from the three-phase diode bridge; and an inverter control unit to detect an imbalanced state of the three-phase AC voltage based on a DC voltage value, and control the inverter based on a detection result of the imbalanced state, the DC voltage value being a detection value of the DC voltage obtained by the voltage detecting unit.

### Effects of the Invention

The electric motor drive device according to the present disclosure has an effect of being able to achieve downsizing of the device and reduction of a processing load.

### BRIEF DESCRIPTION OF DRAWINGS

FIG. 1 is a diagram illustrating an exemplary configuration of an electric motor drive device according to a first embodiment.

FIG. 2 is a flowchart illustrating an example of an operation of the electric motor drive device according to the first embodiment.

FIG. 3 is a graph for explaining a ripple voltage calculated by an inverter control unit according to the first embodiment.

FIG. 4 is a diagram illustrating an exemplary configuration of an electric motor drive device according to a second embodiment.

FIG. 5 is a graph illustrating an example of a relationship between each phase voltage of three-phase AC and a line voltage.

FIG. 6 is a graph illustrating an example of a relationship between each phase voltage of three-phase AC and a DC voltage after rectifying each phase voltage.

FIG. 7 is a graph illustrating a relationship between a DC voltage and a line voltage at a zero-cross point of a phase voltage.

FIG. 8 is a flowchart illustrating an example of an operation of the electric motor drive device according to the second embodiment.

FIG. 9 is a diagram illustrating an exemplary configuration of an air conditioner according to a third embodiment.

### DESCRIPTION OF EMBODIMENTS

Hereinafter, an electric motor drive device and an air conditioner according to embodiments of the present disclosure will be described in detail with reference to the drawings.

### First Embodiment

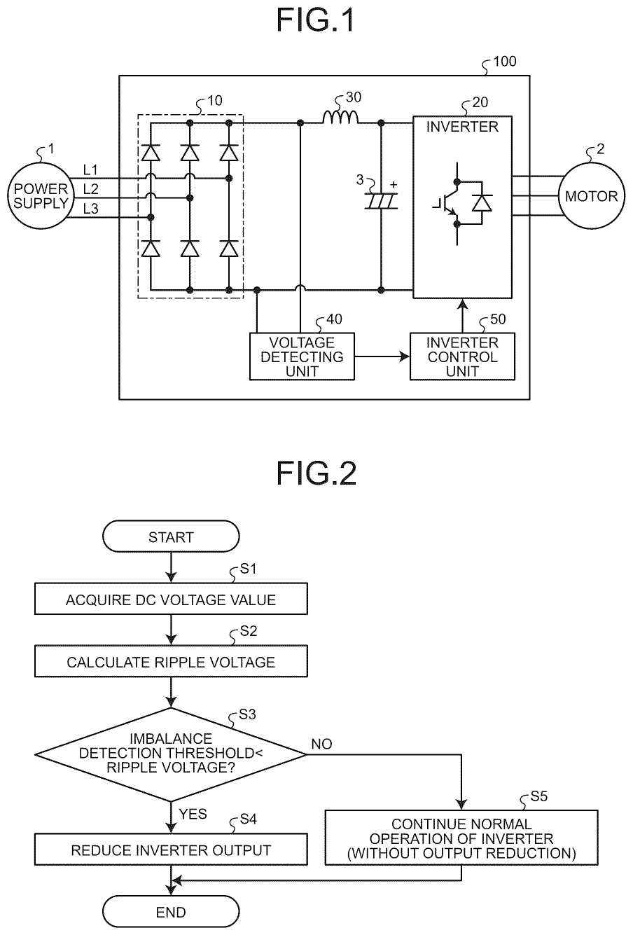

FIG. 1 is a diagram illustrating an exemplary configuration of an electric motor drive device 100 according to a first embodiment. The electric motor drive device 100 is connected to a power supply 1 via three power supply lines L1 to L3, and receives supply of three-phase AC power from the power supply 1 to drive a motor 2. That is, the electric motor drive device 100 converts three-phase AC power supplied from the power supply 1 into three-phase AC power having a desired voltage and frequency, to generate drive power for the motor 2. Note that the motor 2 is a three-phase motor.

The electric motor drive device 100 includes: a three-phase diode bridge 10 which rectifies a three-phase AC voltage supplied from the power supply 1 which is a three-phase AC power supply, to convert the three-phase AC voltage into a DC voltage; an electrolytic capacitor 3 which is a smoothing capacitor for smoothing the DC voltage output from the three-phase diode bridge 10; an inverter 20 which converts the DC voltage smoothed by the electrolytic capacitor 3 into a three-phase AC voltage, and applies the three-phase AC voltage to the motor 2; and a DC reactor 30 which is provided between the three-phase diode bridge 10 and the electrolytic capacitor 3, and reduces a harmonic current included in a DC current flowing between the three-phase diode bridge 10 and the inverter 20. Further, the electric motor drive device 100 includes: a voltage detecting unit 40 which is connected between the three-phase diode bridge 10 and the DC reactor 30, and detects the DC voltage output from the three-phase diode bridge 10; and an inverter control unit 50 to which a DC voltage value is input, the DC voltage value being a detection value of the DC voltage obtained by the voltage detecting unit 40, and gives a command generated on the basis of the input DC voltage value to the inverter 20 to generate drive power for the motor 2. Note that, although not illustrated in FIG. 1, the detection value of the voltage output from the inverter 20 and a voltage command are input to the inverter control unit 50. The inverter control unit 50 generates a command to the inverter 20 on the basis of the detection value of the voltage output from the inverter 20, the voltage command, and the above-described DC voltage value. The voltage detecting unit 40 is implemented by, for example, a voltage sensor. The inverter control unit 50 is implemented by, for example, a microcontroller.

Although detailed operation will be separately described, in the electric motor drive device 100, the inverter control unit 50 determines whether or not the three-phase AC voltage supplied from the power supply 1 is in an imbalanced state on the basis of the detection result of the DC voltage obtained by the voltage detecting unit 40, and reduces an output of the inverter 20 when the three-phase AC voltage is in the imbalanced state.

Here, as described above, when there is an imbalance in the input three-phase AC voltage, an imbalance occurs in an input current, and pulsation (hereinafter referred to as a ripple) also occurs in the DC voltage rectified by the three-phase diode bridge 10. That is, when the three-phase AC voltage is in an imbalanced state, a ripple component included in the DC voltage increases. Therefore, it is possible to detect an imbalance of the three-phase AC voltage by monitoring the DC voltage rectified by the three-phase diode bridge 10. The inverter control unit 50 of the electric motor drive device 100 according to the present embodiment detects the imbalance of the three-phase AC voltage by using such characteristics. As a result, it is not necessary to provide a circuit for detecting a voltage of each phase of the three-phase AC input from the power supply 1, and it is possible to reduce the size and cost of the device.

In addition, the ripple of the DC voltage also occurs when a load of the inverter 20 to which the DC voltage is applied fluctuates. Therefore, the electric motor drive device 100 is configured to detect the DC voltage between the three-phase diode bridge 10 and the DC reactor 30 where an influence of the load fluctuation is small. Note that, a configuration may be adopted in which the DC voltage is detected at a position (for example, between the electrolytic capacitor 3 and the inverter 20) different from the DC voltage detection location illustrated in FIG. 1, when an assumed maximum variation amount of the load connected to the inverter 20 is small, that is, when the ripple generated with the load variation is negligibly small as compared to the ripple generated with the imbalance of the three-phase AC voltage.

FIG. 2 is a flowchart illustrating an example of an operation of the electric motor drive device 100 according to the first embodiment. Specifically, the flowchart of FIG. 2 illustrates an exemplary operation in which the inverter control unit 50 of the electric motor drive device 100 determines the presence or absence of a power supply voltage imbalance, and controls the inverter 20 in accordance with the determination result.

When the electric motor drive device 100 is executing the power conversion operation for generating the drive power for the motor 2, the inverter control unit 50 repeats the operation according to the flowchart of FIG. 2. That is, when the electric motor drive device 100 drives the motor 2, the inverter control unit 50 repeatedly executes a series of processing from the start to the end illustrated in FIG. 2 at a predetermined cycle.

Specifically, the inverter control unit 50 first acquires a DC voltage value (step S1). In particular, the inverter control unit 50 acquires a detection value of a DC voltage from the voltage detecting unit 40.

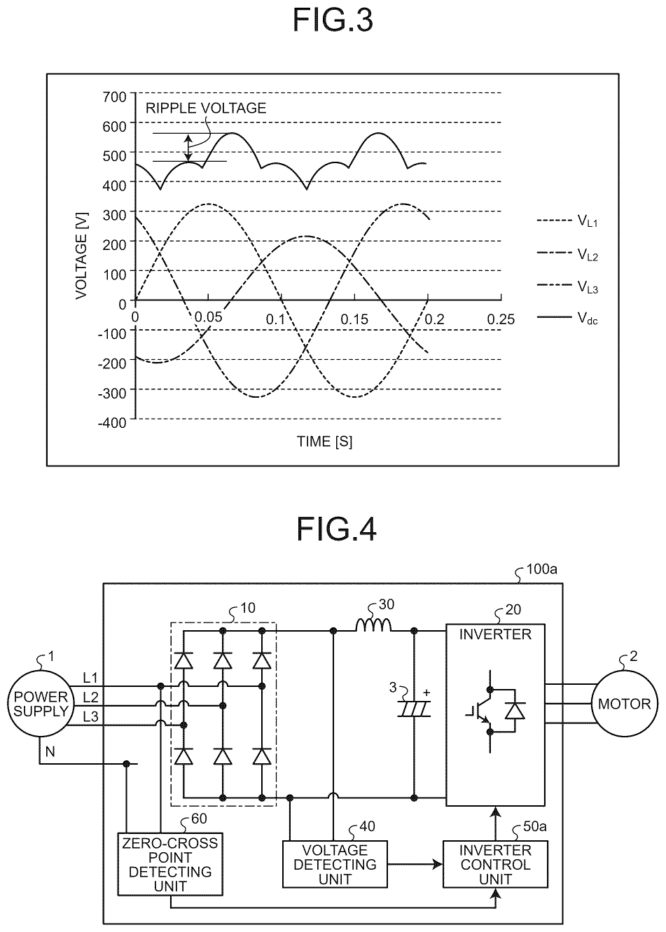

Next, the inverter control unit 50 calculates a ripple voltage on the basis of the DC voltage value acquired in step S1 (step S2). The ripple voltage calculated by the inverter control unit 50 in step S2 will be described with reference to FIG. 3. FIG. 3 is a graph for explaining a ripple voltage calculated by the inverter control unit 50 according to the first embodiment. In FIG. 3, reference character “V_{dc}” represents a DC voltage detected by the voltage detecting unit 40, and reference characters “V_{L1}”, “V_{L2}”, and “V_{L3}” represent voltages of respective phases of three-phase AC input from the three power supply lines L1 to L3 to the electric motor drive device 100. The horizontal axis represents time, and the vertical axis represents a voltage. FIG. 3 illustrates an example of a correspondence relationship between the DC voltage V_{dc} and the voltages V_{L1}, V_{L2}, and V_{L3} of the individual phases of the three-phase AC. As illustrated in FIG. 3, the ripple voltage calculated by the inverter control unit 50 is a difference between magnitudes of adjacent ripples included in the DC voltage, that is, a voltage difference between adjacent vertexes. In step S2, the inverter control unit 50 detects a vertex of the ripple by analyzing the latest DC voltage value acquired from the voltage detecting unit 40 and a DC voltage value acquired in the past, and calculates the ripple voltage from the detected vertex. For example, when the inverter control unit 50 detects the vertex of the latest ripple by analyzing the DC voltage value, the inverter control unit 50 obtains a difference between the detected vertex and the previously detected vertex of the ripple, and sets this difference as the ripple voltage.

Next, the inverter control unit 50 compares the ripple voltage calculated in step S2 with a predetermined threshold for imbalance detection (hereinafter referred to as an imbalance detection threshold) (step S3). Note that, the imbalance detection threshold is determined in advance, for example, by performing an operation simulation of the electric motor drive device 100.

When the ripple voltage is larger than the imbalance detection threshold (step S3: Yes), the inverter control unit 50 determines that the three-phase AC voltage is in an imbalanced state, and reduces the output of the inverter 20 (step S4). For example, the inverter control unit 50 controls the inverter 20 so that a maximum output of the inverter 20 does not exceed N % of a maximum output in normal state. Note that, N<100 is satisfied. The normal state is a state in which the three-phase AC voltage is not imbalanced. N described above may be a variable value. For example, when the ripple voltage and the imbalance detection threshold are greatly different, N may be changed so as to be a small value. In addition, a plurality of different imbalance detection thresholds and a value of N corresponding to each imbalance detection threshold may be prepared, and a value of N to be used may be determined on the basis of a comparison result between the ripple voltage and each imbalance detection threshold.

When the ripple voltage is equal to or lower than the imbalance detection threshold (step S3: No), the inverter control unit 50 determines that the three-phase AC voltage is not in an imbalanced state, that is, determines that the three-phase AC voltage is in the normal state, and continues a normal operation of the inverter 20 (step S5). Note that, in the normal operation, the inverter control unit 50 performs control such that a voltage output from the inverter 20 follows the voltage command.

As described above, the electric motor drive device 100 according to the present embodiment includes: the voltage detecting unit 40 which detects a DC voltage between the three-phase diode bridge 10 and the DC reactor 30; and the inverter control unit 50 which detects an imbalanced state of the three-phase AC voltage on the basis of a ripple of the DC voltage detected by the voltage detecting unit 40, and the inverter control unit 50 reduces the output of the inverter 20 upon detecting the imbalanced state of the three-phase AC voltage. According to the present embodiment, it is possible to achieve the electric motor drive device 100 capable of preventing a defect such as breaker trip and a failure of a component mounted on the substrate when an imbalance of the three-phase AC voltage occurs, and it is possible to achieve downsizing of the device and reduction of a processing load.

### Second Embodiment

The electric motor drive device 100 according to the above first embodiment determines whether or not the three-phase AC voltage is in an imbalanced state by comparing a predetermined imbalance detection threshold and a ripple voltage calculated on the basis of a DC voltage detected by the voltage detecting unit 40 provided between the three-phase diode bridge 10 and the DC reactor 30. On the other hand, in the present embodiment, a description will be given of an electric motor drive device 100a capable of accurately detecting an imbalance even in a case of a large fluctuation of a DC voltage due to an influence of a fluctuation of a load connected to the inverter 20.

FIG. 4 is a diagram illustrating an exemplary configuration of the electric motor drive device 100a according to a second embodiment. In FIG. 4, components in common with those of the electric motor drive device 100 according to the first embodiment illustrated in FIG. 1 are denoted by identical reference numerals. The description of the components denoted by reference numerals identical to those in FIG. 1 will be omitted.

The electric motor drive device 100a has a configuration in which the inverter control unit 50 of the electric motor drive device 100 according to the first embodiment is replaced with an inverter control unit 50a, and a zero-cross point detecting unit 60 is added.

The zero-cross point detecting unit 60 monitors any one phase of a three-phase AC voltage input from the power supply 1 to the electric motor drive device 100a, detects a zero-cross point of the voltage, and outputs a detection result to the inverter control unit 50a. In the configuration illustrated in FIG. 4, the zero-cross point detecting unit 60 detects a zero-cross point of the voltage V_{L1} of the power supply line L1. The zero-cross point detecting unit 60 is implemented by, for example, a voltage sensor, a logic circuit that determines a sign of a voltage detection value obtained by the voltage sensor, and the like.

The inverter control unit 50a generates a command to the inverter 20 on the basis of the DC voltage value detected by the voltage detecting unit 40 and the zero-cross point detected by the zero-cross point detecting unit 60. Specifically, the inverter control unit 50a calculates a voltage (hereinafter, a voltage of one phase is referred to as a phase voltage) of each phase of the three-phase AC voltage input to the electric motor drive device 100a, on the basis of the DC voltage value and the zero-cross point. Then, the inverter control unit 50a determines whether or not the three-phase AC voltage is in an imbalanced state on the basis of the calculated effective value of each phase voltage, and controls the output of the inverter 20 in accordance with a determination result. Note that, in order to simplify the description, an effective value of the phase voltage is referred to as a “phase voltage” in the following description.

Here, a method will be described in which the inverter control unit 50a calculates each phase voltage of the three-phase AC voltage on the basis of the DC voltage value and the zero-cross point.

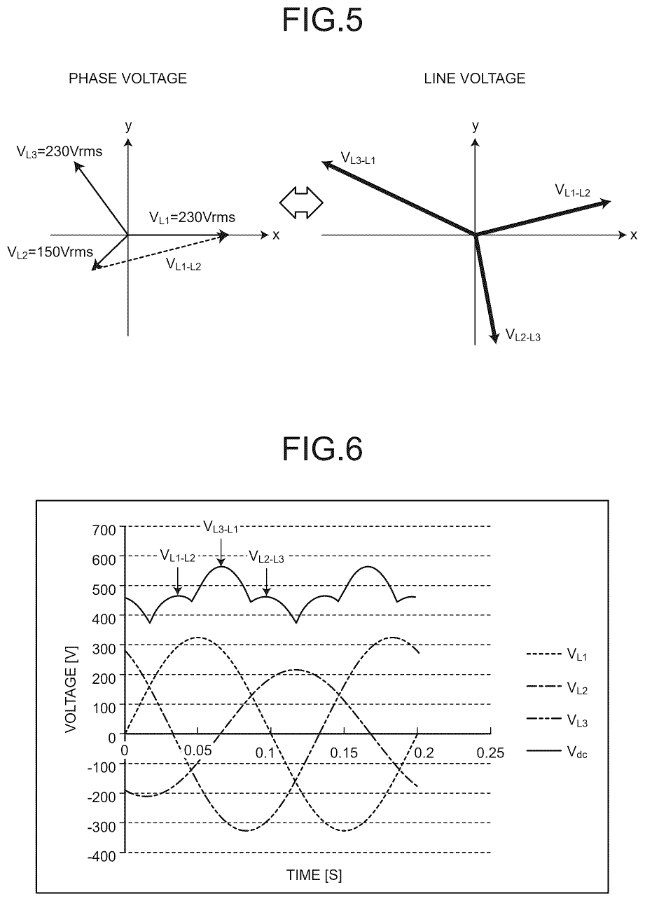

The phase voltages V_{L1}, V_{L2} and V_{L3} of three-phase AC and line voltages V_{L1-L2}, V_{L2-L3} and V_{L3-L1} have a relationship illustrated in FIG. 5. Here, the line voltage V_{L1-L2} is a potential difference between the power supply lines L1 and 12, the line voltage V_{L2-L3} is a potential difference between the power supply lines L2 and L3, and the line voltage V_{L3-L1} is a potential difference between the power supply lines L3 and L1. Note that, FIG. 5 is a graph illustrating an example of a relationship between each phase voltage of three-phase AC and a line voltage.

In addition, there is a relationship illustrated in FIG. 6 between the phase voltages V_{L1}, V_{L2}, and V_{L3} of three-phase AC and the DC voltage V_{dc} obtained by rectifying these phase voltages. Note that, FIG. 6 is a graph illustrating an example of a relationship between each phase voltage of three-phase AC and a DC voltage after rectifying each phase voltage. As illustrated in FIG. 6, a ripple of the DC voltage V_{dc} is generated by an influence of each phase voltage, and each ripple peaks at a timing when each phase voltage crosses zero. The peak at the timing of the phase voltage V_{L1}=0 is caused by an influence of the phase voltages V_{L2} and V_{L3}, and the DC voltage V_{dc} (peak value) at this timing can be regarded as equal to the line voltage V_{L2-L3}. Similarly, the peak at the timing of the phase voltage V_{L2}=0 is caused by an influence of the phase voltages V_{L3} and V_{L1}, and the DC voltage V_{dc} (peak value) at this timing can be regarded as equal to the line voltage V_{L3-L1}. The peak at the timing of the phase voltage V_{L3}=0 is caused by an influence of the phase voltages V_{L1} and V_{L2}, and the DC voltage V_{dc} (peak value) at this timing can be regarded as equal to the line voltage V_{L1-L2}. Note that, the peak value of which ripple of the DC voltage V_{dc} corresponds to which line voltage can be derived from a relationship between phase voltages as long as the zero-cross point of any one phase of the three-phase AC is known. Therefore, the zero-cross point detecting unit 60 of the electric motor drive device 100a detects the zero-cross point of one phase.

Using such a relationship, the inverter control unit 50a calculates each phase voltage of the three-phase AC voltage by the following method.

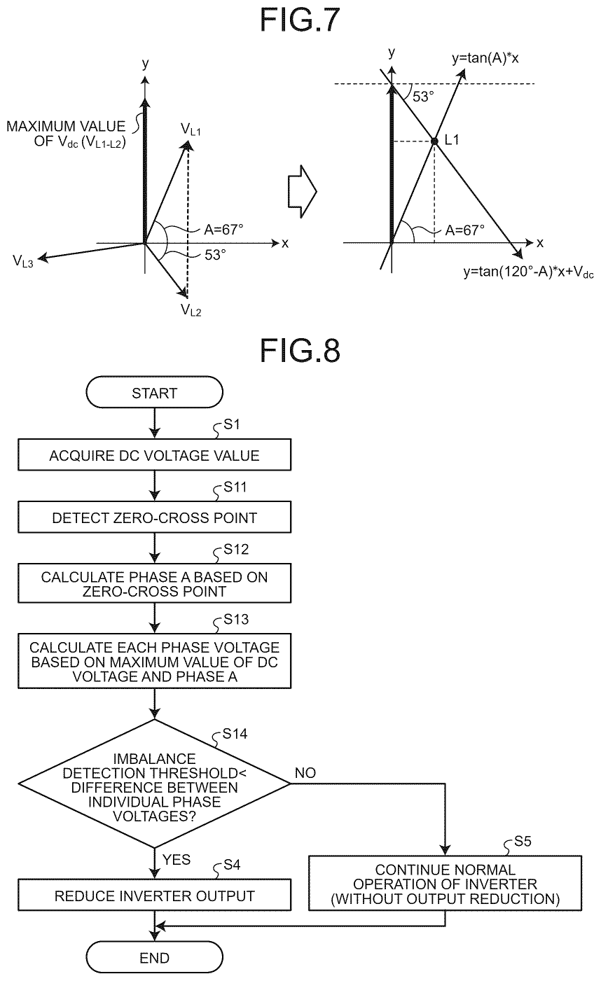

First, the inverter control unit 50a calculates a phase A illustrated in FIG. 7, that is, a phase A of the phase voltage V_{L1} at the zero-cross point of the phase voltage V_{L3}. Note that, since the phase voltage V_{L3}=0 is satisfied at the zero-cross point of the phase voltage V_{L3}, the DC voltage V_{dc} at this time depends on the phase voltages V_{L1} and V_{L2}, and the DC voltage V_{dc}=line voltage V_{L1-L2} is established. FIG. 7 is a graph illustrating a relationship between the DC voltage V_{dc} and the line voltage V_{L1-L2} at the zero-cross point of the phase voltage V_{L3}.

Next, the inverter control unit 50a obtains an intersection L1 illustrated in FIG. 7. Specifically, the inverter control unit 50a obtains coordinates (x, y) of the intersection L1 of two lines obtained by substituting the calculated phase A into the following Formulas (1) and (2).

$$y = tan ( A ) \times x \qquad ( 1 )$$

$$y = tan ( 120 ° - A ) \times x + {V}_{dc} \qquad ( 2 )$$

Next, the inverter control unit 50a substitutes the phase A into the following Formula (3) to obtain x at the intersection L1 illustrated in FIG. 7, and further substitutes the obtained x into Formula (1) to obtain y.

$$x = {V}_{dc} / ( tan ( A ) + tan ( 120 ° - A ) ) \qquad ( 3 )$$

Next, the inverter control unit 50a substitutes x and y obtained above into the following Formula (4) to obtain the phase voltage V_{L1}.

$${V}_{L 1} = √ ( x \hat{} 2 + y \hat{} 2 ) \qquad ( 4 )$$

In addition, the inverter control unit 50a obtains the phase voltage Viz by using the phase A and the phase voltage V_{L1} obtained above and the following Formulas (5) and (6).

$${V}_{dc} = {V}_{L 1} \times sin ( A ) - {V}_{L 2} \times sin ( A - 120 ° ) \qquad ( 5 )$$

$${V}_{L 2} = ( {V}_{L 1} \times sin ( A ) - {V}_{dc} ) / sin ( A - 120 ° ) \qquad ( 6 )$$

The inverter control unit 50a obtains the phase voltage V_{L3} by a similar method. Specifically, the inverter control unit 50a calculates a phase B of the phase voltage V_{L1} at a zero-cross point of the phase voltage V_{L2}, and obtains the phase voltage V_{L3} by using the calculated phase B, the phase voltage V_{L1}, and the following Formulas (7) and (8).

$${V}_{dc} = {V}_{L 3} \times sin ( B - 240 ° ) - {V}_{L 1} \times sin ( B ) \qquad ( 7 )$$

$${V}_{L 3} = ( {V}_{L 1} \times sin ( B ) - {V}_{dc} ) / sin ( B - 240 ° ) \qquad ( 8 )$$

Note that, in the present embodiment, the zero-cross point detecting unit 60 detects the zero-cross point of the phase voltage of any one phase of the three-phase AC voltage, but the inverter control unit 50a may have a function of detecting the zero-cross point. That is, means (for example, a voltage sensor) for detecting an instantaneous value of the phase voltage of any one phase of the three-phase AC voltage may be provided, and the inverter control unit 50a may detect the zero-cross point on the basis of a detection result.

Next, an operation of the electric motor drive device 100a according to the present embodiment will be described. FIG. 8 is a flowchart illustrating an example of an operation of the electric motor drive device 100a according to the second embodiment. In FIG. 8, step numbers identical to those in FIG. 2 indicate identical processing. The description of the processing with step numbers identical to those in FIG. 2 will be omitted.

After the inverter control unit 50a acquires the DC voltage value in step S1, the zero-cross point detecting unit 60 detects a zero-cross point of the phase voltage V_{L1} (step S11). Next, the inverter control unit 50a calculates the above-described phase A on the basis of the zero-cross point detected by the zero-cross point detecting unit 60 (step S12).

Next, the inverter control unit 50a calculates each phase voltage of three-phase AC on the basis of the phase A and a maximum value of the DC voltage V_{dc} detected by the voltage detecting unit 40 (step S13). Here, the maximum value of the DC voltage V_{dc} is a peak voltage of each ripple of the DC voltage V_{dc}. The inverter control unit 50a calculates each phase voltage (V_{L1}, V_{L2}, V_{L3}) by the method described above.

Next, the inverter control unit 50a checks whether or not a difference between the individual phase voltages of the three-phase AC is larger than a predetermined imbalance detection threshold (step S14). Note that, the imbalance detection threshold used in step S14 is different from the imbalance detection threshold used in step S3 illustrated in FIG. 2 described in the first embodiment. In step S14, the inverter control unit 50a calculates a difference between the phase voltages V_{L1} and V_{L2}, a difference between the phase voltages V_{L2} and V_{L3}, and a difference between the phase voltages V_{L3} and V_{L1}. When one or more of the calculated differences is larger than the imbalance detection threshold, the inverter control unit 50a determines that the three-phase AC voltage is in an imbalanced state (step S14: Yes), and reduces an output of the inverter 20 (step S4). When all of the calculated differences are equal to or smaller than the imbalance detection threshold, the inverter control unit 50a determines that the three-phase AC voltage is not in an imbalanced state (step S14: No), and continues the normal operation of the inverter 20 (step S5).

As described above, the electric motor drive device 100a according to the present embodiment includes: the voltage detecting unit 40 which detects a DC voltage between the three-phase diode bridge 10 and the DC reactor 30; the zero-cross point detecting unit 60 which monitors any one phase of the three-phase AC voltage input from the power supply 1 and detects a zero-cross point of the voltage; and the inverter control unit 50a which calculates a phase voltage (effective value) of the three-phase AC voltage on the basis of the DC voltage detected by the voltage detecting unit 40 and the zero-cross point detected by the zero-cross point detecting unit 60, and detects an imbalanced state of the three-phase AC voltage on the basis of a difference between the phase voltages. When the inverter control unit 50a detects the imbalanced state of the three-phase AC voltage, the inverter control unit 50a reduces the output of the inverter 20. According to the present embodiment, it is possible to achieve the electric motor drive device 100a capable of preventing a defect such as breaker trip and a failure of a component mounted on the substrate when an imbalance of the three-phase AC voltage occurs, and it is possible to achieve downsizing of the device. In addition, since the phase voltage of the three-phase AC voltage is calculated and whether or not to be in an imbalanced state is determined on the basis of the phase voltage, the imbalanced state can be accurately detected.

### Third Embodiment

In a third embodiment, an application example of the electric motor drive devices 100 and 100a described in the first embodiment and the second embodiment will be described.

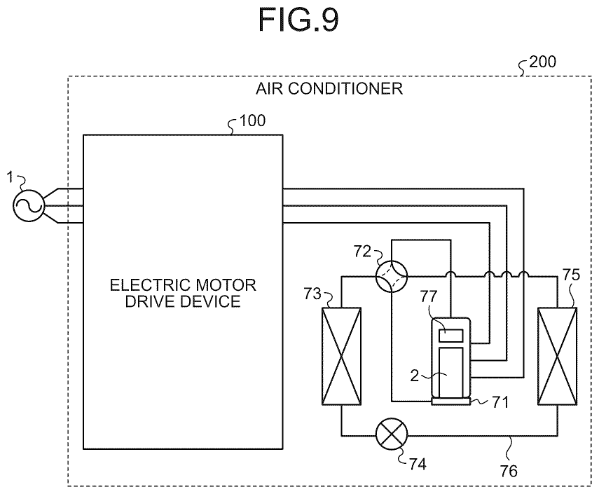

FIG. 9 is a diagram illustrating an exemplary configuration of an air conditioner 200 according to the third embodiment. The air conditioner 200 illustrated in FIG. 9 is implemented by applying the electric motor drive device 100 described in the first embodiment. The air conditioner 200 is an example of a refrigeration cycle device implemented by applying the electric motor drive device 100. Note that, the electric motor drive device 100 may be replaced with the electric motor drive device 100a described in the second embodiment.

The air conditioner 200 includes the electric motor drive device 100 connected to the power supply 1 which outputs three-phase AC power, a compressor 71, a four-way valve 72, an outdoor heat exchanger 73, an expansion valve 74, an indoor heat exchanger 75, and a refrigerant pipe 76. The compressor 71 includes the motor 2 which is driven by three-phase AC power supplied from the electric motor drive device 100, and a compression mechanism 77 which compresses a refrigerant. The motor 2 operates the compression mechanism 77.

The refrigerant circulates through the compressor 71, the four-way valve 72, the outdoor heat exchanger 73, the expansion valve 74, the indoor heat exchanger 75, and the refrigerant pipe 76, to form a refrigeration cycle.

The air conditioner 200 is not limited to a separate air conditioner in which an outdoor unit is separated from an indoor unit, and may be an integrated air conditioner in which the compressor 71, the indoor heat exchanger 75, and the outdoor heat exchanger 73 are provided in one housing.

Note that, although the air conditioner 200 has been described as an example of the refrigeration cycle device including the electric motor drive device 100, the refrigeration cycle device is not limited to the air conditioner 200, and may be a refrigerator, a heat pump hot water supply device, or the like.

In addition, in the present embodiment, the exemplary configuration has been described in which the motor 2 is applied to a drive source of the compressor 71 and the motor 2 is driven by the electric motor drive device 100. However, the motor 2 driven by the electric motor drive device 100 may be applied as a drive source for driving an indoor unit blower and an outdoor unit blower (not illustrated) included in the air conditioner 200. In addition, the motor 2 driven by the electric motor drive device 100 may be applied as a drive source of each of the indoor unit blower, the outdoor unit blower, and the compressor 71.

As described above, the air conditioner 200 according to the present embodiment can detect a voltage imbalance of the power supply 1 without being affected by a fluctuation of a load connected to the inverter 20, by using the electric motor drive device 100 according to the first embodiment or the electric motor drive device 100a according to the second embodiment. In addition, when the voltage imbalance is detected, the output of the inverter 20 is reduced, and it is possible to prevent a defect such as breaker trip and a failure of a component mounted on the substrate. Accordingly, reliability and product life of the air conditioner 200 can be maintained. Even when the electric motor drive device 100 or 100a described in the first or second embodiment is applied to a refrigeration cycle device other than the air conditioner 200, effects similar to those of the air conditioner 200 can be obtained.

The configurations illustrated in the above embodiments illustrate one example and can be combined with another known technique, and it is also possible to combine embodiments with each other and omit and change a part of the configuration without departing from the subject matter of the present disclosure.

### REFERENCE SIGNS LIST

1 power supply; 2 motor; 3 electrolytic capacitor; 10 three-phase diode bridge; 20 inverter; 30 DC reactor; 40 voltage detecting unit; 50, 50a inverter control unit; 60 zero-cross point detecting unit; 71 compressor; 72 four-way valve; 73 outdoor heat exchanger; 74 expansion valve; 75 indoor heat exchanger; 76 refrigerant pipe; 77 compression mechanism; 100, 100a electric motor drive device; 200 air conditioner.

1. An electric motor drive device comprising:
a three-phase diode bridge to rectify a three-phase alternating-current (AC) voltage, to convert the AC voltage into a direct-current (DC) voltage;
a smoothing capacitor to smooth the DC voltage;
a DC reactor provided between the three-phase diode bridge and the smoothing capacitor;
an inverter to convert the DC voltage smoothed by the smoothing capacitor into an AC voltage, and output the AC voltage to a motor;
a voltage detector to detect a DC voltage output from the three-phase diode bridge;
an inverter controller to detect an imbalanced state of the three-phase AC voltage based on a DC voltage value, and control the inverter based on a detection result of the imbalanced state, the DC voltage value being a detection value of the DC voltage obtained by the voltage detector, and
a zero-cross point detector to detect a zero-cross point of any one phase of the three-phase AC voltage, wherein
the inverter controller detects an imbalanced state of the three-phase AC voltage based on the DC voltage value and the zero-cross point detected by the zero-cross point detector.

2. The electric motor drive device according to claim 1, wherein
when the inverter controller detects an imbalanced state of the three-phase AC voltage, the inverter controller reduces an output of the inverter so as to make the output smaller than when the three-phase AC voltage is in a normal state.

3. The electric motor drive device according to claim 1, wherein
the inverter controller detects a vertex of a ripple included in a DC voltage output from the three-phase diode bridge based on the DC voltage value, and determines that the three-phase AC voltage is in an imbalanced state when a difference between vertices of adjacent ripples is larger than a predetermined threshold.

4. (canceled)

5. The electric motor drive device according to claim 1, wherein
the inverter controller detects a vertex of a ripple included in a DC voltage output from the three-phase diode bridge based on the DC voltage value, calculates a voltage of each phase of the three-phase AC voltage based on the detected vertex and the zero-cross point, and compares the calculated voltages of individual phases to detect an imbalanced state of the three-phase AC voltage.

6. An air conditioner comprising:
the electric motor drive device according to claim 1, wherein
the electric motor drive device generates drive power for a motor that operates a compression mechanism that compresses a refrigerant circulating in a refrigeration cycle.

7. The electric motor drive device according to claim 2, wherein
the inverter controller detects a vertex of a ripple included in a DC voltage output from the three-phase diode bridge based on the DC voltage value, calculates a voltage of each phase of the three-phase AC voltage based on the detected vertex and the zero-cross point, and compares the calculated voltages of individual phases to detect an imbalanced state of the three-phase AC voltage.

8. The electric motor drive device according to claim 3, wherein
the inverter controller detects a vertex of a ripple included in a DC voltage output from the three-phase diode bridge based on the DC voltage value, calculates a voltage of each phase of the three-phase AC voltage based on the detected vertex and the zero-cross point, and compares the calculated voltages of individual phases to detect an imbalanced state of the three-phase AC voltage.
